(19) United States
(12) Patent Application Publication
(10) Pub. No.: US 2006/0182324 A1
(43) Pub. Date: Aug. 17, 2006

(54) Medical imaging system and method for retrieving medical images

(75) Inventor: Wataru Motoki, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/347,354

(22) Filed: Feb. 3, 2006

(30) Foreign Application Priority Data
Feb. 16, 2005 (JP) JP2005-039347

(51) Int. Cl. G06K 9/00

(52) U.S. Cl. 382/128

(57) ABSTRACT

A medical imaging system in which at least one image forming device and a plurality of control devices for retrieving and storing medical mages that were formed by the image forming device are connected to each other, wherein the other control devices in which medical images are stored are searched, medical images are retrieved from one control device among the other control devices that were searched, and the retrieved medical image is transferred.

### TECHNICAL FIELD

This invention relates to a medical imaging system which creates and manages medical images and a method for retrieving medical images.

### BACKGROUND

In the field of diagnosis, medical images obtained by radiography are being digitalized, and for example, Japanese Patent Application Laid-Open No. 10-23201 describes a medical imaging system which performs all the processes from data creation to output of medical images. In conventional medical imaging systems, a plurality of image forming devices such as CR (Computed Radiography) or cassette reading devices or FPD (Flat Panel Detector) and the like and control devices which control image formation and store the medical images that were created, are included in the conventional medical imaging system as shown in FIG. 5, and the medical images that are stored by these control devices are output to a single image processing device.

A radiologist controls image formation at the image forming device using the control device, and the image quality of the medical image that was created or the position of the object (patient) subjected to radiography is checked at a display of the control device, and then if there is no need to redo radiography, the medical image is sent to the image processing device. At the image processing device, the medical images that have been received from the control devices are subjected to image processing, and when the authorized radiologists among many radiologists determine that the image is appropriate for diagnosis (this image is referred to as image for radiographic interpretation hereinafter), and the image for radiographic interpretation is sent to a manager device (a server which stores and manages images for radiographic interpretation), a PACS (Picture Archiving and Communication System for medical application: a system which sends the image to a terminal for radiographic interpretation) or a film output device and the like.

However, a number of radiography rooms are usually at separate locations on each floor or on each ward of the hospital. Only a limited number of technicians are able to determine whether the medical images that have been taken are appropriate for diagnosis or have the authority to perform adjustments by image processing. As a result, the technicians who have this type of authority must make rounds to the image processing devices that have been installed at various locations in the hospital in order to check the quality of the medical images and adjust image processing.

When the quality of the medical image is checked and image processing adjustment is performed, in some cases, it is necessary to perform image processing once again on an image that has already been determined to be an image for radiographic interpretation. However, in conventional medical imaging systems, the medical image is only output to one direction, such as from the control device to the image processing device and from the image processing device to an external device like the image server. As a result, the technician must go to the control device where the original of the image for radiographic interpretation is stored and operate the control device and search for the medical image (raw data of the original image) that needs to be processed again and then send it to the image processing device, and thus the process is complicated.

In order to solve this problem, a structure can be considered in which at the manager device, not only the images for radiographic interpretation that have been checked are managed, but the original images are also managed together with these images, and the original images from the manager device are distributed to the other image processing devices. However, in CT (Computed Tomography) or MRI (Magnetic Resonance Imaging), in one examination, hundreds of medical images are created. When managing these images together at the manager device, a large amount of memory must be available, and it can be supposed that sometimes this configuration is not possible. In addition, even with the above-described configuration, the technician must go to the location where the manager device is installed in order to retrieve the original images or the like. Generally, the number of manager devices installed is not as much as the number of control devices and as a result, there are cases where there is no manager device near the technician, and thus the operation efficiency is poor.

### SUMMARY

The object of this invention is to provide a medical imaging system in which original images can be easily retrieved.

The above object is realized by a medical imaging system in which at least one image forming device and a plurality of control devices for retrieving and storing medical images formed by the image forming device are connected to each other, wherein other control devices in which medical images are stored are searched, and medical images are retrieved from one control device from among the other control devices that were searched, and the retrieved medical images are transferred.

In this invention, because the medical images stored in another control device can be retrieved from one control device, when medical images stored in any of the control devices are needed, the necessary medical images can be easily retrieved by operating a nearby control device.

### BRIEF DESCRIPTION OF THE DRAWINGS

FIG. 1 shows the system configuration of the medical imaging system of this embodiment.

FIG. 2 shows the internal configuration of the control device.

FIG. 3 shows an example of the image manager table.

FIG. 4 shows a flowchart for describing the flow of the processes in the medical imaging system.

FIG. 5 describes the medical imaging system of the prior art.

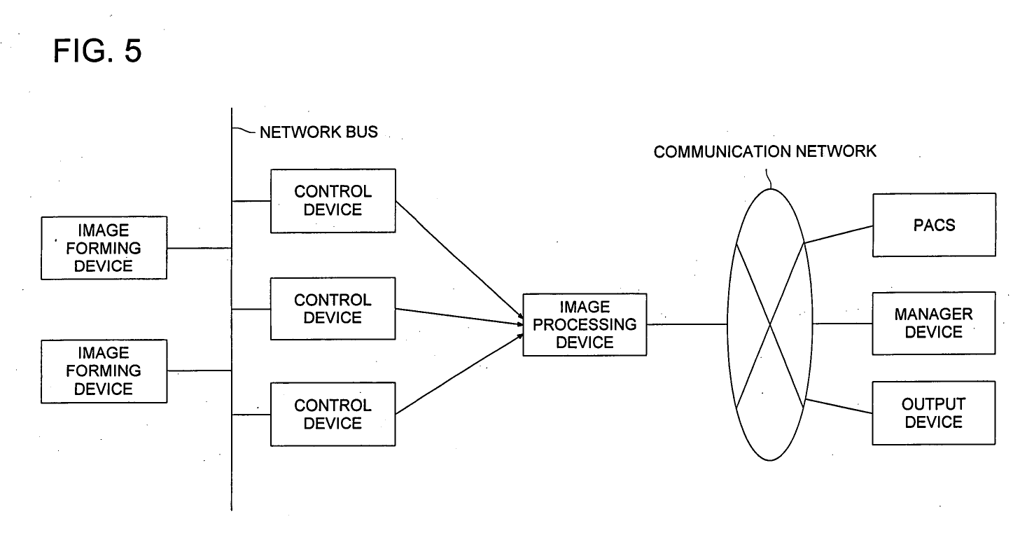

FIG. 6 shows the internal structure of the control device.

FIG. 7 is a flowchart for describing the flow of the processes in the medical imaging system of another embodiment.

### DESCRIPTION OF THE PREFERRED EMBODIMENT

First, the configuration will be described.

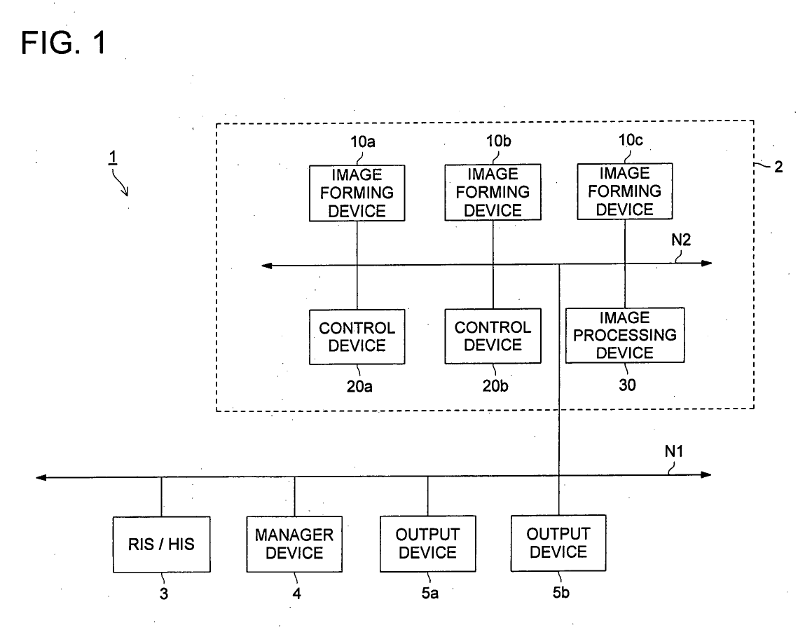

FIG. 1 shows the system configuration of the medical imaging system 1 of this embodiment. The medical imaging system 1 comprises a digital imaging network section 2 which includes an image forming device 10; a control device 20; and an image processing device 30; an RIS/HIS 3; a manager device 4; an output device 5 which are configured so as to send information to and from each other via a network bus N1.

The following is a description of each component device.

In the CR network section 2, the plurality of image forming devices 10a, 10b and 10c, the plurality of control devices 20a and 20b, and the image processing device 30 are connected to each other via the network bus N2. It is to be noted that in the CR network section 2, the number of the image forming devices 10, the control devices 20 and the image processing devices 30 that are installed is not particularly limited.

Each of the image forming devices 10a, 10b and 10c creates digital data for the image taken (medical image) of the patient based on control by the control device 20a or 20b. A CR, CT, FPD (flat panel detector), a cassette reading device or the like, or a device which creates medical images using X-ray radiography may be suitably used here. The following describes one of the image forming devices 10a, 10b and 10c as the image forming device 10, but all of the image forming devices 10a, 10b and 10c have the same configuration.

The image forming device 10 is a device which conforms to DICOM (Digital Imaging and Communication in Medicine) which is the standard specification for medical imaging and communication thereof. Related information for the formed medical image (such as patient information relating to the patient whose medical image was taken or radiographic information that pertains to the radiography or the medical examination, or examination information and the like) may be input from outside, and automatic image formation is also possible. The image forming device 10 may attach the abovementioned related information to the medical image that was formed by writing it into the header for the medical image, and the medical image and the related information is sent to the control device 20a or 20b which performed image formation.

Each of the control devices 20a and 20b obtains order information from the RIS/HIS 3 (including patient information relating to the patient being subjected to radiography or instructions relating to radiography or the medical examination), and the image formation in the image forming device 10 is controlled based on the order information. In addition, the medical information that is formed by the image forming device 10 is retrieved and this is stored and managed as the original image and distribution of the retrieved medical image is also controlled. It is to be noted that the plurality of control devices 20a and 20b which are on the network bus N2 control at least one of the image forming devices 10a, 10b and 10c for which instruction is given based on each set of order information and then the image that is formed is sent to the control device which gave the instruction. One of the control devices 20a and 20b is described as the control device 20, but the control devices 20a and 20b have the same configuration.

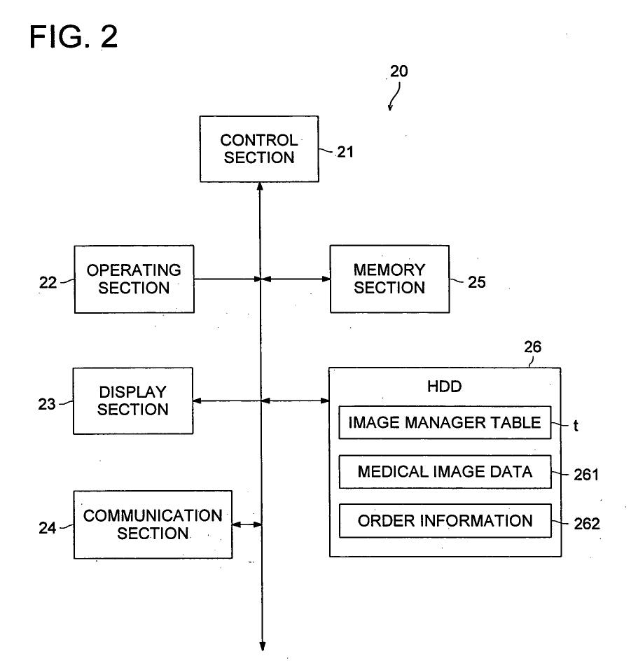

FIG. 2 shows the internal structure of the control device 20.

As shown in FIG. 2, the control device 20 comprises the control section 21, the operation section 22, the display section 23, the communication section 24, the memory section 25, and the HDD (hard disk drive) 26.

The control section 21 comprises a CPU (central processing unit), RAM (random access memory) and the like, and the various control programs are read from the memory section 25 by the CPU and the RAM is opened. General control of execution of the processes in accordance with the programs is then performed and various computations are also done.

The operation section 22 comprises a keyboard and a mouse or the like and creates operation signals corresponding to the operation of the keyboard and mouse and outputs the operation signals to the control section 21.

The display section 23 comprises a LCD (liquid crystal display) or the like and performs various displays based on instructions from the control section 21, such as display of the operation screen at the time of image processing or display of the medical image after the processing.

The communication section 24 comprises communication interfaces such as a router and a modem and communicates with external devices on the network bus N2 based on instructions from the control section 21. For example, the communication section 24 may receive medical images that were formed, from the image forming device 10 and send medical images stored in the HDD 26 to the image processing device 30.

The memory section 25 stores various control programs and parameters required for executing processing using the program or data such as processing results or the like.

The HDD 26 stores data 261 for the medical images (original images) retrieved from the image forming device 10. That is to say, it functions as the image storing section. In addition, the HDD 26 stores image management information for managing the stored medical images as the image manager table t.

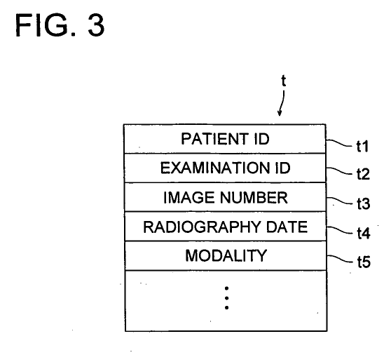

As shown in FIG. 3, the image manager table t has items. of information required for specifying a medical image such as the patient ID (t1) for the patient for whom a medical image has been taken; a unique medical examination ID (t2) that is assigned to each examination; a unique image ID (t3) for each image that is formed; a radiography date (t4), the modality name ID (t5) which is used in the radiography and the like, and these are stored in the form of a database.

It is to be noted that the memory capacity for the HDD 26 needs to be available in excess to some extent.

Normally, in diagnosis, after the medical image is formed, medical radiographic interpretation by a medical practitioner (doctor) begins within one week at most. That is to say, the technician must check the image quality of the medical image in the image processing device 30 and perform image processing within one week, and thus memory capacity capable of storing the original images for at least one week from the time of creation is needed.

For example, if the medical image handled by each control device 20 is 2000 pixels×2500 pixels per image, and about 100 medical images are formed per day, if the capacity of the HDD is 40 GB (and the image storage capacity is 20 GB), 2000 images can be stored for approximately 20 days.

In addition, the HDD 26 stores order information 262 received from the RIS/HIS 3. Examples of the order information include various information such as the name of the patient being subjected to radiography, the patient ID, patient information such as gender and the like, date, modality name used in the radiography, radiography information relating to radiography instructions such as body part for radiography and the like, examination information such as unique medical examination ID for each examination, or name of medical practitioner (doctor) who gave instructions to perform examination, and conditions for image reading and the like.

In FIG. 1, the image processing device 30 is a device which can be installed as a work station where the technician may check image quality and the like of the medical image that is sent from the control section 20, and has large capacity memory capable of temporarily storing the medical images and performs necessary image processing of the medical images. Examples of the image processing include reducing/enlarging processes, gradation conversion processes, sharpness adjustment processes, dynamic range processing and the like.

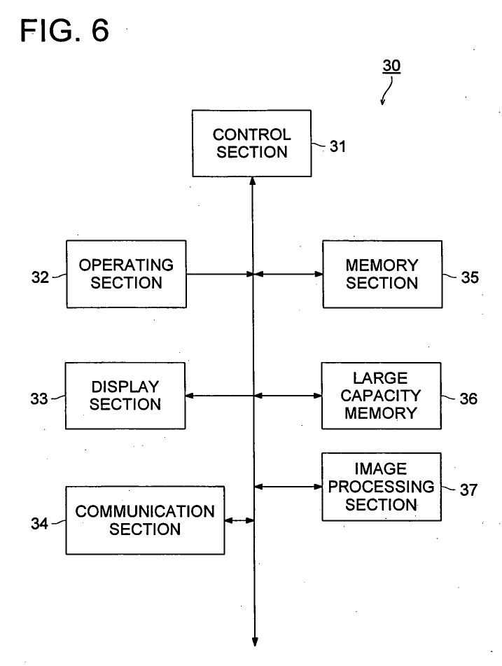

FIG. 6 shows the internal configuration of the image processing device 30.

The image processing device 30 comprises: a control section 31, an operation section 32, a display section 33, a communication section 34; a memory section 35, a large capacity memory 36, and an image processing section 37.

The control section comprises a CPU, RAM and the like and reads the control program and controls each section of the image processing device 30.

The operation section 32 creates operation signals corresponding to the operation of the keys and the mouse and outputs the operation signals to the control section 31. The display section 33 performs various displays such as display of the operation screen at the time of image processing or display of the medical image after the processing.

The communication section 34 communicates with external devices on the network busses N1 and N2 based on instructions from the control section 31. For example, the communication section 34 may receive medical images sent from the image forming device 20 and send processed images that were processed at the image processing section 37 along with related information to the manager device 4 shown in FIG. 1.

The memory section 35 stores various control programs and parameters required for executing processing using the programs or data such as processing results or the like. The large capacity memory 36 temporarily stores the medical images sent from the control device 20.

The image processing section 37 performs the abovementioned image processing for the medical images temporarily stored in the large capacity memory 36.

The image processing device 30 writes information relating to image processing such as the processing parameters used in the image processing onto the header of the processed image after the image processing is carried out and the technician performs the operations for determining that the image is an image for radiographic interpretation, and the processed image and the related information are sent to the manager device 4 via the network paths N2 and N1.

FIG. 1 will be used once again to describe each of the devices 3-5 on the network bus N1.

RIS/HIS (Radiology Information System/Hospital Information System) 3 is a system for overall management of information in the radiology department or in the hospital. At the RIS/HIS 3, requests for medical examination from the medical practitioner are received and the abovementioned order information is created. In addition, the formed order information is sent to the control devices 20a and 20b via the network path N1 and N2.

The manager device 4 comprises a control section, a communication section, a memory section and an HDD (hard disk drive), all of which are not shown. The manager device 4 stores and manages processed images that have been determined to be images for radiographic interpretation on the CR network section 2 along with the related information. In addition, the destination to which the processed images are to be delivered is determined and the processed images are sent to the determined destination.

The output devices 5a and 5b respectively output the processed images that were distributed by the manager device 4. A monitor (soft copy device) or a film output device (hard copy device) which does film output may be suitably used as the output device 5.

Next the operation of the medical imaging system 1 will be described.

First, the flow of operations from creation to storage of the medical image will be described with the case where a cassette reading device is used in the image forming device 10 as an example.

When order information is formed based on a request from a medical practitioner on RIS/HIS 3, the order information is sent to the control devices 20a and 20b. At the control device 20, the distributed order information is displayed as a list at the control device 20 based on operations by a radiologist. Registration (linking the cassette ID with the order information) of the recording means (cassette) used for the radiography, or setting of the control information when reading the cassette (conditions such as sampling pitch and the like) are performed based on order information selected by the radiologist from among the order information on the list display. When the cassette which has been subjected to radiography is inserted into a suitably selected image forming device 10 from among the image forming devices 10a, 10b and 10c, the set control information is reflected at the image forming device 10 at the time of reading of the cassette ID that has been input.

In the image forming device 10, medical images are formed from the cassette that has been subjected to radiography in accordance with the control information that is input from the control unit 20. In addition, when radiography information and like is written into the header of the medical image as the related information for medical image that was formed, the order information which the cassette uses is sent to the control device 20 which is registered. In other words, by operating the control device 20, it is ensured that the radiologist can accept the medical image formed at the image forming device 10 at the control device which the radiologist is operating.

At the control device 20, the medical image that was retrieved from the image forming device 10 is displayed at the display section 23 and the radiologist is able to check the position of the object that was subjected to radiography as well image quality and the like using the display. If the image is not suitable, radiography is to be done again, while if it is suitable the operation section 23 is operated and instructions are given for storage of the medical image.

At the control device 20, the medical image for which instructions to store have been given is stored; as an original image in the HDD 26 and an image control table t shown in FIG. 3 is created based on the related. information for the medical image. Next, the medical image that is stored in the HDD 26 is copied along with the related information and sent to the image processing device 30.

At the image processing device 30, when the medical images sent from each of the control devices 20 and the related information is received, they are temporarily stored in the large capacity memory 36 as images for processing. In addition, the medical images that are received are displayed at the display section 33 based on operations by the technician. The technician checks the quality and the like of the displayed medical image and gives instructions to perform various image processing as necessary. Processing is then performed for the medical images by the image processing section 37, and if the image quality and the like are good, the operations that set a processed image as an image for radiographic interpretation is carried out.

At the image processing device 30, the processed images that have been determined to be enough imaages for radiographic interpretation are sent to the manager device 4 via the network buses N1 and N2.

At the manager device 4, the images for radiographic interpretation that are received from the image processing device 30 are stored in the HDD of the manager device 4.

As described above, when the processed images that are determined to be images for radiographic interpretation are sent to the output device 5 and the like and then output, and is used for diagnosis by a medical practitioner, there are some cases where adjustment of image quality and the like is necessary after the image is determined to be an image for radiographic interpretation.

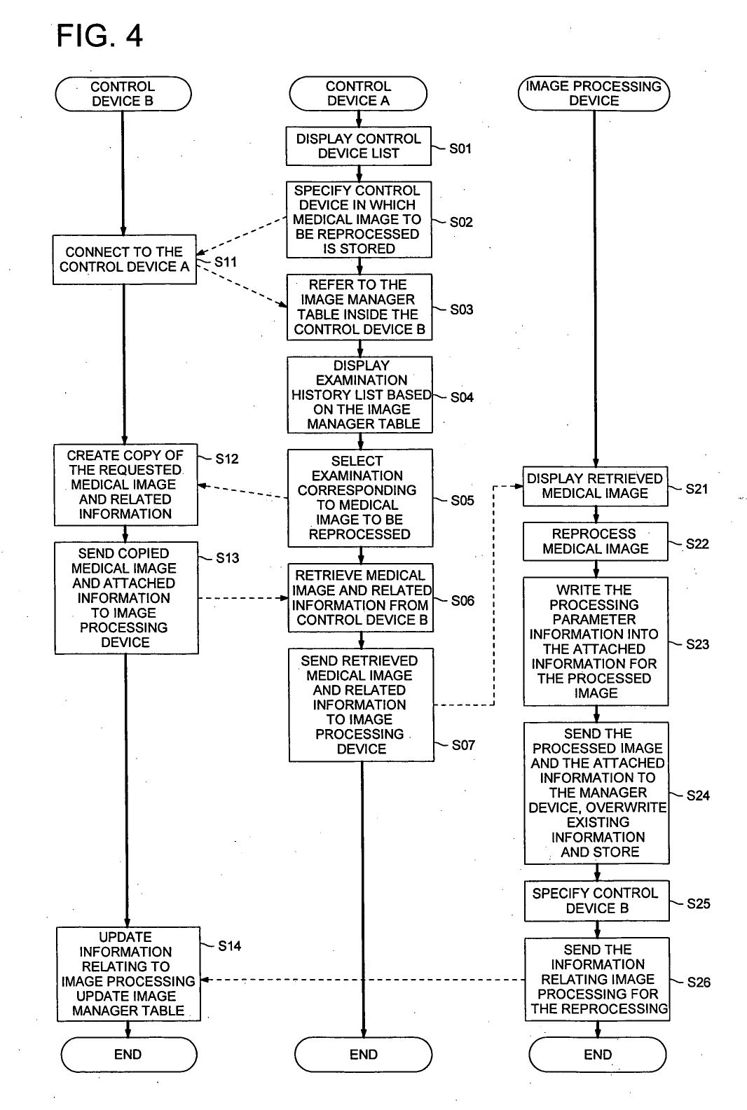

The operation in the case where image processing is needed after the image is determined to be for radiographic interpretation, is described in the following with reference to FIG. 4.

This description assumes that when the need for re-processing arises, the technician goes to the closest control device 20 and gives instructions for re-processing. When instructions are given for re-processing, the process shown in the following is started at the medical imaging system 1 which includes the control device 20. It is to be noted that the original images stored in the control devices 20 are called “medical images” and the processed images that are determined to be for radiographic interpretation are called “images for radiographic interpretation” hereinafter.

First, at the control device 20, all of the control devices 20 in which medical images are stored are searched and search results are displayed as a list on the display section 23 (Step S01). At this time, the control section 21 functions as an image searching section. The technician performs an operation for specifying the control device 20 in which the medical image for re-processing is stored from among the control devices 20 displayed in the list. In the following, in order to make a distinction between the control device 20 which the technician is operating and the control device 20 which has been specified and stores the medical image, the former will be called control device A, while the latter will be called control device B. It is to be noted that in FIG. 4, Step S01 to Step S07 show the processes in the control device A, while Step S11 to Step S13 show the processes in the control device B, and Step S21 to Step S24 show the processes in the image processing device.

When the control device B in which medical images are stored is specified via the operation section 22 (Step S02), the control device B is connected via the communication section 24 to the control device A (Step S11), and the image manager table t that is stored inside the HDD 26 of the control device B is referred to by the control section 21 (Step S03). Next, in the control device A, an examination history list in which the medical images stored in the control device B are listed for each patient examination is formed by the control section 21 based on the image manager table t (Step S04). The technician selects the patient corresponding to the medical image which is to be re-processed, the medical examination, and the medical image in that order, from the displayed examination history list.

In the control device A, the request information requesting the selected medical image and the attached medical information is sent to the control device B via the communication section 24 based on the selection operation (Step S05). In the control device B, a copy of the medical image and the related information requested at Step S05 is formed from the medical image and related information stored in the HDD 26 of the control device B based on the request information from the control device A (Step S12) and sent to the control device A (Step S13). In the control device A, the medical image and related information that was selected at the Step S05 are retrieved (Step S06). At this time, the control section 21 functions as an image retrieving section.

Next, at the control device A, the retrieved medical images and the related information are sent to the image processing device 30 via the communication section 24 (Step 807). At the image processing device 30, the medical images received from the control device A are displayed (Step S21). The technician checks the medical images using the display and performs re-processing by instructing the necessary image processing and the like. At the image processing device 30 processed images are formed by performing image re-processing based on operation instructions (Step S22). Next, when the technician determines that the image is an image for radiographic interpretation, information relating to the image processing is written in the header of the image for radiographic interpretation and the information is thereby attached (Step S23).

Next, the image for radiographic interpretation resulting from reprocessing and information attached thereto are sent from the image processing device 30 to the manager device 4. In the manager device 4, an image for radiographic interpretation with the same image number (one previously processed) already exists, but when the image for radiographic interpretation is newly received from the image processing device 30, the new image for radiographic interpretation and the related information are written over the existing ones and stored (Step S24).

Next in the image processing device, the related information for the processed image that was reprocessed in Step S22 is referred to by the control section 31 and the control device B in which the original medical image is stored is specified (Step S25) and the information relating to image processing for the reprocessing is sent to the control device B (Step S26). At the control device B that was specified in Step S25, the information relating to image processing after reprocessing is added to the related information for the medical images stored in the HDD 26 by the control section 21 to thereby perform updating and the image manager table t is also updated by adding the information on reprocessing to the relevant items (Step S14), and the process ends. At this time, the control section 21 functions as the updating section.

As described above, in this embodiment, a medical image stored in another control devices 20 can be retrieved from one control device 20, and can be transferred to the image processing device 30. As a result, even in the case where the need arises to reprocess an image that has already been determined to be an image for radiographic interpretation, search and retrieval of the medical image from a nearby control device 20 may be done, and the operation efficiency of the technician can be improved. In the case of the system configuration in which only the images for radiographic interpretation are stored and managed at the manager device 4, the medical images are distributed to each of the control devices 20 and stored, but in this embodiment, the medical images stored in another control device 20 can be retrieved from any control device 20, and thus the images distributed and stored at the control devices 20 can be shared.

In addition, when the medical images stored in the other control devices 20 are searched, the search is done using the image search table t and thus the search efficiency for the medical images is improved.

Furthermore, because the information relating to image processing at the time of reprocessing is written on as related information for the image for radiographic interpretation after reprocessing, and the image for radiographic interpretation and related information is overwritten in the manager device 4, duplication of the image for radiographic interpretation can be prevented.

It is to be noted that the medical image system 1 of this embodiment is a favorable example in which the present invention is applied, but is not intended to limit this invention.

For example, in the above embodiment, the case in which the medical image stored in the control device 20 for reprocessing are retrieved is described, but the configuration may also be such that in the case where a plurality of image processing devices 30 are also installed, because the medical images prior to image processing (original images) can be temporarily stored in large capacity memory in the image processing device 30 also, the medical images can be retrieved from any of the other image processing devices 30 as well.

In this case, the image processing device 30 functions as a control device 20 having an image processing section. That is to say, the image processing device 30 operates in the same manner as the control device 20 described in the above embodiment and the medical images stored in the image processing devices 30 can be retrieved from each other. As a result, the technician may operate a nearby image processing device 30 and easily perform reprocessing. In addition, in the case where a medical image is retrieved from an image processing device 30, the medical image that is stored in the control device 20 still has information relating to the previous image processing attached as related information, and thus information relating to the image processing is sent to the control device 20 after the reprocessing. At the control device 20, the information relating to image processing subsequent to reprocessing is added to the related information for the medical image to thereby update said information.

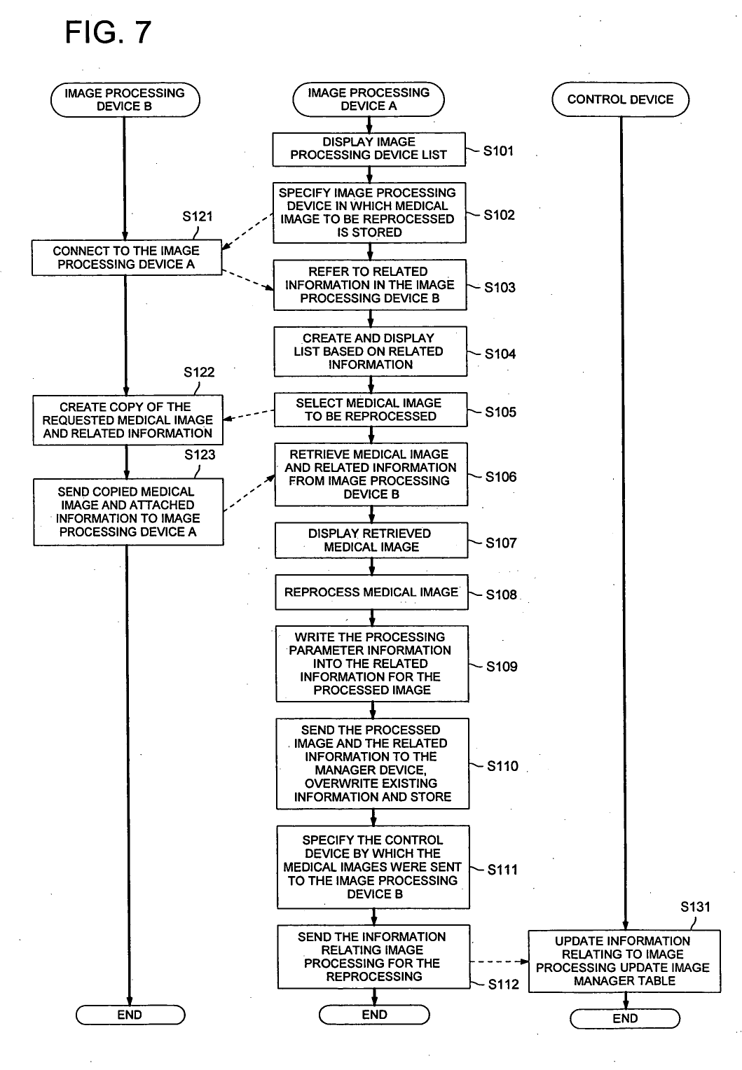

The following is a description of the case where a image processing is done again using the image processing device 30, with reference to FIG. 7.

In the image processing device 30, all of the image processing devices 30 in which medical images are stored are searched by the control section 31 and search results are displayed as a list on the display section 33 (Step S101). At this time, the control section 31 functions as an image searching section. The technician performs an operation for specifying the image processing devices 30 in which is medical images for re-processing is stored, from among the image processing devices 30 displayed in the list. In the following, in order to make a distinction between the image processing devices 30 which the technician is operating and the image processing device 30 which has been specified, the former will be called image processing device A, while the latter will be called image processing device B. It is to be noted that in FIG. 8, Step S101 to Step S112 show the processes in the image processing device A, while Step S111 to Step S113 show the processes in the image processing device B, and Step S131 shows the processes in the control device 20.

When the image processing device B in which medical images are stored is specified via the operation section 32 (Step S102), the image processing device B is connected via the communication section 34 at the image processing device A (Step S121), and the medical images and related information temporarily stored in the large capacity memory 36 of the image processing device B is referred to by the control section 31 (Step S103). Next, in the control device A, a medical image list which is stored in the control device B is created by the control section 31 based on the related information referred to (Step S104). The technician selects the medical image which is to be re-processed, from the displayed list.

In the image processing device A, the request information requesting the selected medical image and the related information is sent to the image processing device B via the communication section 34 based on the selection operation (Step S105). In the image processing device B, a copy of the medical image and the related information requested at Step S105 is created from the medical image and related information stored in large capacity memory 26 of the image processing device B based on the request information from the image processing device A (Step S122) and sent to the image processing device A (Step S123). In the image processing device A, the medical image and related information that was selected at the Step S105 are retrieved (Step S106). At this time, the control section 31 functions as an image retrieving section.

Next, at the image processing device A, the medical images sent from the image processing device B are displayed (Step S107). The technician checks the medical images using the display and performs re-processing by instructing the necessary image processing and the like. At the image processing device B, processed images are formed by performing image reprocessing based on operation instructions (Step S108). Next, when the technician determines that the image is an image for radiographic interpretation, information relating to the image processing is written in the header of the image for radiographic interpretation as related information and thereby attached (Step S109).

Next, the image for radiographic interpretation and related information resulting from reprocessing are sent from the image processing device A to the manager device 4. At the manager device 4, an image for radiographic interpretation with the same image number (one previously processed) already exists, but when the image for radiographic interpretation is newly received from the image processing device A, the new image for radiographic interpretation and the related information are written over the old ones and stored (Step S110).

Next in the image processing device A, the related information for the processed image that was reprocessed in Step S108 is referred to by the control section 31 and the control device 20 in which the original medical image is stored, or in other words, the control device 20 which sent the medical images to image processing device B, is specified (Step S111) and the information relating to image processing for the reprocessing is sent to the specified control device 20 (Step S112). At the control device 20 that was specified in Step S111, the information relating to image processing after reprocessing is added to the related information for the medical images stored in the HDD 26 by the control section 21 to thereby perform updating and the image manager table t is also updated by adding the reprocessed information to the relevant items (Step S131), and then the process ends. At this time, the control section 21 functions as the updating section.

As described above, in this embodiment, because the medical images stored in other image processing devices 30 can be retrieved from one control device 30, and reprocessing can be carried out, even in the case where the need arises to reprocess an image that has already been determined to be an image for radiographic interpretation, a search is done for the medical image from a nearby image processing device 30 and retrieval is easy, and thus the operation efficiency of the technician can be improved.

In addition, reprocessing can be repeated while checking the processed image that was subjected to reprocessing at the display section 32 until a desired image quality is obtained, and thus a high quality image for radiographic interpretation can be obtained in a short time.

Furthermore, the medical images stored in the control device 20 and the image processing device 30 respectively can be retrieved from each other. As a result, the number of devices that the technician may operate in order to carry out reprocessing is increased and operation efficiency is good. In addition, in the case where a plurality of control devices 20 are connected to a suitably selected image forming device 10 from among a plurality of image forming devices 10, when transactions are conducted at each control device 20 in order to retrieve images, the communication load on the network N2 is large. As a result, in the case where a medical image stored in the control device 20 is to be retrieved from the image processing device 30, one control device 20 is specified from among a plurality of control devices 20, and thus the communication load on the network N2 is kept at the minimum.

In addition, the control devices 20 may also have the functions of the image processing device 30.

If the HDD 26 that is loaded in each of the controls devices 20 has a memory capacity of about 30 GB, this is sufficient for image processing. It is preferable the control devices 20 have image processing functions in that the terminal which is used for determining the image for radiographic interpretation is closer to the technician in charge.

Furthermore, in this embodiment, the example is described in which a cassette is used for radiography and a cassette reading device is used as the image forming device 10, but the configuration is not limited thereto, and FPD may also be used. In this case, when the order information is registered in the control device 20, the ID of the FPD used in the radiography is registered, and with this ID as the key, the FPD can return the read image to the control device 20 in which the order information is registered.

In addition, the ID number or the like of the control device 20 in which the medical image is stored is added to the related information for the image for radiographic interpretation and then stored, and specifying the control device 20 in which a medical image which is needed at the time of reprocessing becomes easy, and thus this configuration is preferable.

The other aspects of this application are shown in the following.

(1) A medical imaging system comprising: at least one image forming device; a plurality of control devices which retrieve and store medical images formed by the image forming device, wherein

the plurality of control devices can retrieve medical images stored in one control device from another control device.

(2) The medical imaging system described in (1), wherein the plurality of control devices can retrieve medical images along with related information relating to the image that is attached to said medical image.

(3) The medical imaging system described in (2), comprising:

an image processing device which performs image processing for medical images; and

the control device performs image processing using the image processing device for the medical images that were retrieved from another control device, and adds information relating to this image processing to the related information for the images for radiographic interpretation which were subjected to the image processing, and then updates the relevant related information.

(4) The medical imaging system described in (3), comprising:

a plurality of image processing devices and each image processing device can store medical images which are to be subjected to image processing and

the plurality of image processing device are configured such that medical images stored in one image processing device can be retrieved from the other image processing device.

(5) The medical imaging system described in (4), wherein

the plurality of control devices and the plurality of image processing devices can retrieve medical images stored in another control device or another image processing device from one control device or one image processing device.

(6) The medical imaging system described in (2), wherein

the plurality of control devices have an image processing means which performs image processing for a medical image, and

when one control device performs image processing for the medical image that has been retrieved from another control device, the information relating to the image processing is sent to another control device, and the other control device adds related information for the medical image to the information relating to the image processing that was sent and updates the information.

(7) A medical imaging system, comprising:

at least one image forming device;

a plurality of control devices for retrieving and storing the medical images formed by the image forming devices;

an image processing device for performing image processing on the medical images stored in the control device; and

a manager device which stores the image for radiographic interpretation which has been subjected to image processing and performs output control, and

the plurality of control devices can retrieve medical images stored in one control device from another control device.

(8) The medical imaging system described in any of (1) to (7), comprising:

a plurality of image forming devices, and

the plurality of image forming devices supplies the formed medical image to the control device which controlled the image formation from among the plurality of control devices.

(9) A method for retrieving medical images in the medical imaging system comprising: at least one image forming device; a plurality of control devices which retrieve and store medical images formed by the image forming device, wherein

the medical images stored in one control device can be retrieved from another control device.

(10) The method for retrieving medical images described in (9), wherein:

the medical image is retrieved along with related information relating to the image which is attached to the medical image.

(11) The method for retrieving medical images described in (10), wherein:

the medical imaging system comprises an image processing device for performing image processing on the medical image; and

the control device performs image processing using the image processing device for the medical image that was retrieved from the other control device, and adds information relating to this image processing to the related information for the image for radiographic interpretation which was subjected to the image processing, and then updates the relevant related information.

(12). The method for retrieving medical images described in (11), wherein:

the medical imaging system comprises a plurality of image processing devices that can store medical images for image processing; and

the medical images stored in one image processing device can be retrieved from another image processing device.

(13) The method for retrieving medical images described in (12), wherein:

medical images stored in other control devices or other image processing devices can be retrieved from one control device or one image processing device.

(14) The method for retrieving medical images described in (10), wherein:

the plurality of control devices have an image processing means which performs image processing for medical images, and

when one control device performs image processing for the medical image that has been retrieved from another control device, the information relating to the image processing is sent to another control device, and the other control device adds related information for the medical image to the information relating to the image processing that was sent and updates the information.

(15) The method for retrieving medical images in a medical imaging system comprising:

at least one image forming device;

a plurality of control devices for retrieving and storing the medical image formed by the image forming devices;

an image processing device for performing image processing on the medical images stored in the control device; and

a manager device which stores the image for radiographic interpretation which has been subjected to image processing and performs output control, wherein

medical images stored in one control device can be retrieved from another control device.

(16) The method for retrieving medical images described in any of (9) to (15), wherein:

the medical imaging system comprises a plurality of image forming devices, and

the plurality of image forming devices supplies the formed medical image to the control device which controlled the image formation from among the plurality of control devices.

According to the aspect described in (1) or (9), because medical images stored in other control device can be retrieved from one control device, when a medical image stored in any of the control devices is needed, the medical, image that is needed can be easily retrieved by operating a nearby control device.

According to the aspect described in (2), (3), (10) or (11), in the case where reprocessing is necessary after the medical image has been subjected to reprocessing once and the image for radiographic interpretation is retrieved from another control device and image processing is performed again, the related information can also be updated to information for the reprocessing. As a result, even when reprocessing is performed, the reprocessed image will correspond to the related information.

According to the aspects described in (4) or (12), transactions for the medical images can be conducted between image processing devices, and even in the case where a medical image that is stored in another image processing device is needed while operating an image processing device, said medical image can be easily retrieved.

According to the aspects described in (5) or (13), transactions for the medical images can be conducted between a control device and an image processing device, and even in the case where a medical image that is stored in a control device is needed while operating an image processing device, said medical image can be easily retrieved. In addition, the number of devices that can be operated in order to retrieve the desired medical image is increased, and thus operational efficiency is improved.

According to the aspects described in (6) or (14), in the case where reprocessing is necessary after the medical image has been subjected to reprocessing once and the image for radiographic interpretation is retrieved from another control device and image processing is performed again; the related information can also be updated to information for the reprocessing. As a result, even in the case where reprocessing is performed, the reprocessed image corresponds with the related information. In addition, because the control device has image processing functions, the terminal for performing the determining operation for the image for radiographic interpretation can be located closer to the technician in charge.

According to the aspects described in (7) or (15), even in the case where only processed images are stored in the manager device, the medical images stored in another control device can be retrieved from one control device and thus when a medical image stored in any of the control devices is needed, the medical image that is needed can be easily retrieved by operating a nearby control device.

According to the aspects described in (8) or (16), even if the control device controls a suitably selected image forming device at the time of image forming, the medical image formed at the image forming device can be retrieved.

(17) A medical imaging system in which at least one image forming device and a plurality of control devices for retrieving and storing medical images that were formed by the image forming device are connected to each other, the plurality of control devices comprising:

an image storage section for storing medical images;

an image search section for searching the other controls devices in which a medical image is stored;

an image retrieving section for retrieving medical images from one control device among the other controls devices that were searched, and

a communication section for transferring the medical images.

(18) The medical imaging system described in (17), wherein the image retrieving section retrieves the medical image along with related information relating to the image that has been attached to said medical image.

(19) The medical imaging system described in (17) comprising:

an image processing device that is connected to a plurality of control devices, and performs image processing for the medical images; and

a manager device that is connected to image processing device and stores the medical images that were subjected to image processing at the image processing device, and

the communication device transfers medical images to the image processing device.

(20) The medical imaging system described in (17), wherein

the image memory section stores the medical image and the related information relating to the image that is attached to said medical image, and

each of the plurality of control devices has an updating section which adds information relating to this image processing that is attached to the medical image that was subjected to image processing to the related information, and updates the related information in the case where the image processing is performed using the image processing device.

(21) The medical imaging system described in (17) wherein,

at least one control device from among the plurality of control devices has an image processing section that performs image processing for medical images, and

the medical imaging system has a manager device which stores the medical image that was subjected to image processing at the image processing section; and

the communication device transfers medical images subjected to image processing to the manager device.

(22) The medical imaging system described in (21), wherein the communication section of the control device having the image processing section sends information relating to the image processing to another control device in the case where the image processing is performed for a medical image retrieved from the other control device, and the other control device has an updating section which adds the information relating to this image processing that was sent to the related information for the medical image, and updates the information.

(23) The medical imaging system described in any of (17) to (22) comprising:

a plurality of image forming devices; and

each of the plurality of image forming devices supplies the formed medical image to the control device which controlled the image formation from among the plurality of control devices.

(24) The medical imaging system described in any of (17) to (23), wherein

the image storage section stores an image manager table which includes items of information necessary for specifying a medical image and

the search section searches the other control devices in which medical images are stored with reference to the image manager table of the other control devices.

(25) A method for retrieving medical images in the medical imaging system comprising: at least one image forming device; a plurality of control devices which retrieve and store medical images formed by the image forming device, wherein the method comprises the steps of:

searching the other control devices in which medical images are stored,

retrieving the medical image from one control device from among the other control devices that been searched; and

transferring the medical image that has been retrieved.

(26) The method for retrieving medical images described in (25) wherein:

the medical image is retrieved along with related information relating to the image which is attached to the medical image in the step of retrieving the medical image.

(27) The method for retrieving medical images described in (25) wherein:

the transferred medical image is subjected to image processing in the image processing device that connected with the control device from which the medical image is retrieved, and

the medical image that was subjected to image processing is stored in the manager device that is connected to the image control device.

(28) The method for retrieving medical images described in (27) wherein, in the case where the image processing is performed in the image processing device, information relating to this image processing is added to the related information that is attached to the medical image that was subjected to image processing in the other control device and the related information is updated.

(29) The method for retrieving medical images described in (25) wherein,

the retrieved medical images are subjected to image processing;

the medical images that have been subjected to image processing are transferred to the manager device that is connected to the control device from which the medical images were retrieved; and

the medical images that have been subjected to image processing are stored in the manager device that is connected to the control device from which the medical image was retrieved.

(30) The method for retrieving medical images described in (29) wherein, in the case where image processing is performed on a medical image that is retrieved from another control device, the information relating to the image processing is sent to the other control device; and

the information relating to the image processing that is sent is added to the related information for the medical image at the other control device and the information is updated.

(31) The method for retrieving medical images described in any of (25) to (30) wherein, the other control devices in which the medical images are stored are searched by referring to the image control table which includes the items of information needed for specifying the medical images stored in advance in the other control devices in the step of searching said other control devices.

What is claimed is:

1. A medical imaging system in which at least one image forming device and a plurality of control devices for retrieving and storing medical images that were formed by the image forming device are connected to each other wherein, each of the plurality of control devices comprises:
an image storage section for storing medical images;
an image search section for searching the other control devices in which medical images are stored;
an image retrieving section for retrieving a medical image from one control device among the other controls devices that were searched, and
a communication section for transferring the medical images.

2. The medical imaging system described in claim 1, wherein
the medical image retrieving section retrieves the medical image along with related information relating to the image that was attached to the medical image.

3. The medical imaging system described in claim 1 comprising:
an image processing device that is connected to a plurality of control devices, and performs image processing for the medical images; and
a manager device that is connected to the image processing device and stores the medical images that were subjected to image processing at the image processing device, and
the communication device transfers medical images to the image processing device.

4. The medical imaging system described in claim 3, wherein the image storage section stores the medical image and the related information relating to the image that is attached to said medical image, and
each of the plurality of control devices has a updating section which adds information relating to this image processing to the related information that is attached to the medical image that was subjected to image processing to the related information, and updates the related information in the case where the image processing is performed using the image processing device.

5. The medical imaging system described in claim 1 wherein,
at least one control device from among the plurality of control devices has an image processing section that performs image processing for medical images, and
the medical imaging system has a manager device which stores the medical image that was subjected to image processing at the image processing section; and
the communication device transfers medical images that were subjected to image processing to the manager device.

6. The medical imaging system described in claim 5, wherein the communication section of the control device having the image processing section sends information relating to the image processing to another control device in the case where the image processing is performed for a medical image retrieved from the other control device, and
the other control device has an updating section which adds the information relating to this image processing that was sent to the related information for the medical image, and updates the information.

7. The medical imaging system described in claim 1 comprising:
a plurality of image forming devices; and
each of the plurality of image forming devices supplies the formed medical image to the control device which controlled the image formation from among the plurality of control devices.

8. The medical imaging system described in any of claim 1, wherein
the image storage section stores an image manager table which includes items of information necessary for specifying a medical image and
the searching section searches the other control devices in which medical images are stored by referring to the image manager table of the other control devices.

9. A method for retrieving medical images in the medical imaging system comprising: at least one image forming device; a plurality of control devices which retrieve and store medical images formed by the image forming device, wherein the method comprises the steps of:
searching the other control devices in which medical images are stored,
retrieving the medical image from one control device from among the other control devices that been searched; and
transferring the medical image that has been retrieved.

10. The method for retrieving medical images described in claim 9, wherein:
the medical image is retrieved along with related information relating to the image which is attached to the medical image in the step of retrieving the medical image.

11. The method for retrieving medical images described in claim 9, wherein:
the transferred medical image is subjected to image processing in the image processing device that connected with the control device from which the medical image is retrieved, and
the medical image that was subjected to image processing in the manager device that is connected to the image control device is stored.

12. The method for retrieving medical images described in claim 11 wherein, in the case where the image processing is performed in the image processing device, information relating to this image processing is added to the related information that is attached to the medical image that was subjected to image processing in the other control device and the related information is updated.

13. The method for retrieving medical images described in claim 9 wherein,
the retrieved medical image is subjected to image processing;
the medical image that has been subjected to image processing is transferred to the manager device that is connected to the control device from which the medical image was retrieved; and
the medical image that has been subjected to image processing is stored in the manager device that is connected to the control device from which the medical image was retrieved.

14. The method for retrieving medical images described in claim 13 wherein, in the case where image processing is performed on a medical image that is retrieved from another control device, the information relating to the image processing is sent to the other control device; and
the information relating to the image processing that is sent is added to the related information for the medical image at the other control device and the information is updated.

15. The method for retrieving medical images described in claim 9 wherein, the other control devices in which the medical images are stored are searched by referring to the image control table which includes the items of information needed for specifying the medical images stored in advance in said other control devices in the step of searching said other control devices.
